(19) United States
(12) Patent Application Publication
(10) Pub. No.: US 2011/0091606 A1
(43) Pub. Date: Apr. 21, 2011

(54) Dietary Supplements in Beverages or Other Forms, and Methods of Use and Production

(76) Inventor: Todd Ehrlich, Atlanta, GA (US)

(21) Appl. No.: 12/888,097

(22) Filed: Sep. 22, 2010

Related U.S. Application Data
(60) Provisional application No. 61/245,125, filed on Sep. 23, 2009.

(51) Int. Cl. A23L 2/52; A23L 1/30; A23L 1/302

(52) U.S. Cl. 426/63; 426/61

(57) ABSTRACT

Dietary supplements and methods of making and using them are disclosed. These supplements may contain an enzyme component and a vitamin component.

### RELATED APPLICATION

Benefit is claimed from U.S. Provisional Patent Application No. 61/245,125, filed Sep. 23, 2009, entitled “Beverages and Method for Producing Beverages” which is incorporated by reference herein.

### FIELD OF THE INVENTION

This generally relates to dietary supplements and methods of making and using them and more particularly to dietary supplements for performance and recovery enhancement.

### BACKGROUND

The diets of many people require supplementation for good health and/or performance. Common reasons for this need include poor choices of food and beverages and those related to practical aspects of getting enough of a particular “requirement” in a reasonable amount of readily available, ordinary food and beverages, in some circumstances at least. Multi-vitamin pills and various sports drinks are common forms of such supplementation.

Most sports drinks focus on hydration, since this is an obvious and important need relating to physical activity. Hydration is the one of the easiest things to address by a sports drink, and most such drinks are over 90% water-based. Some drinks now on the market focus on increasing energy.

However, there appears to be little or no attention paid to issues such as reducing inflammation that often accompanies physical activity; inflammation often results in poor physical performance and some degree of pain or discomfort. Typical conventional products attempt to artificially increase energy and/or replace depleted water, sugars and/or amino acids, and miss addressing inflammation.

Gatorade® uses a sugar and electrolyte complex in water to improve hydration, but it may also promote water retention during consumption in situations other than strenuous activity. Red Bull®, which is categorized as an energy drink, is based heavily on caffeine; heavy caffeine consumption can have undesirable effects in many instances. Mountain Dew® is considered by many to be a sort of energy drink, probably due to its high caffeine content as well.

Like these examples, most “functional” beverages on the market today, use ingredients in a “brute force” way; that is, they load up on an excessive amount of a few, specific ingredients that are thought to deliver a desired effect. This “brute force” approach is often ineffective in reality and may even be counterproductive or harmful; this may be especially true when considering maintaining longer term performance. There is normally a more complex mixture of ingredients (often in particular amounts and/or proportions) required to deliver the desired effect.

Other forms of dietary supplementation exist in addition to beverages, such as bars or pills. Similar comments as to the “brute force” approach as noted above for conventional beverages apply to many conventional products in these forms as well.

As a result, there is a need for improved dietary supplements that promote good health and/or performance in beverage, bar, pill and/or other form.

### SUMMARY

Dietary supplements and methods of making and using them are provided in accordance and consistent with the present invention. One such dietary supplement comprises an enzyme component and a vitamin component. In one embodiment of this dietary supplement, the enzyme component comprises bromelain, lipase, amylase, protease other than bromelain or serrapeptase, invertase, beta-glucanase and serrapeptase, and the vitamin component comprises vitamin B2, vitamin B3, vitamin B5, vitamin B12, sodium chloride, monopotassium phosphate, sodium citrate, citric acid, caffeine, d-glucuronolactate, a ginger root extract, a green tea extract, inositol, ginseng root, taurine, milk thistle and vitamin E.

One of the methods for making a dietary supplement in accordance with the present invention comprises mixing a group of materials comprising an enzyme component comprising at least one item selected from the group consisting of bromelain and serrapeptase and a vitamin component comprising a ginger root extract.

A method of use for the dietary supplements in accordance with the present invention is a method of treatment comprising administering a dietary supplement in accordance with the present invention.

### DETAILED DESCRIPTION

In addition to perhaps providing for improved hydration, increased energy and/or other benefits, dietary supplements in beverage or other form in accordance with the present invention may provide for increasing the length of sustained athletic performance, probably by reducing effects of exertion that diminish performance over time and/or the removal of the waste products that are created in the process. These supplements may enhance performance by delaying the onset of muscle inflammation and fatigue, and by promoting cleansing by blood fortified with enzymes that remove waste. Besides possible performance/endurance effects, these dietary supplements may speed recovery after exertion.

A dietary supplement in beverage or other form in accordance with the present invention may have three main functions that facilitate its effects. First, the supplement may act to reduce inflammation and potentially provide analgesic effects; inflammation caused by exertion is often related to diminished athletic performance and to pain. The ingredients of these supplements often focus on reducing inflammation and therefore the associated painful effects of inflammation. It is believed that prolonged inflammation in the muscles, like the kind encountered during or after exercise, leads to a need for extended recovery time and to increased pain associated with recovery.

Second, these supplements may introduce metabolizing agents into the blood stream that allow the body to detoxify waste related to over exertion, which otherwise can lead to increased recovery times. These metabolizers may be in the form of enzymes similar in type to that which the body ordinarily creates on its own naturally, but in limited supply. Increasing the supply of these metabolic agents would likely allow the body to increase the speed at which waste removal and recovery occur.

In addition to the first two effects, these dietary supplements may also cause increased blood flow and speed other metabolic processes.

Compared to conventional supplements, dietary supplements in accordance with the present invention may promote anti-inflammation as a significant characteristic. Compared to Red Bull®, which is categorized as an energy drink, and seemingly Mountain Dew® as well, supplements in accordance with the present invention are often low in caffeine and apparently use caffeine primarily to give the system a metabolic boost to speed the absorption of recovery ingredients. Compared to Gatorade®, dietary supplements in accordance with the present invention are often more complex; Gatorade® uses a sugar and electrolyte complex in water to improve hydration, while the ingredient composition in at least many dietary supplements in accordance with the present invention are more sophisticated. Although hydration promotion may not be a central focus, supplements in accordance with the present invention may deliver a mix of electrolyte ingredients to the body to replace essential electrolytes.

Advantages of various dietary supplements in beverage or other form in accordance with the present invention may include, but are not limited to: (i) low calories per serving, (ii) an enzyme mix that may help reduce inflammation and promote healthy digestion, (iii) a vitamin mix (which may include herbs, minerals and/or other constituents) that may reduce inflammation (especially expected in implementations having a ginger root extract), (iv) the use of ingredients, such as EGCG (epigallocatechin-3-gallate) green tea extract, that may stimulate the metabolism in order to speed delivery of the recovery ingredients, (v) probable mitigation of the effect of alcohol consumption, therefore alleviating the “hangover” caused by excessive alcohol consumption (the supplement consumed before, with and/or after the alcohol), (vi) use of ingredients believed to maintain or augment homeostasis in the blood and digestion and (vii) if included, green tea ingredients may offer thermogenic effects. There may be some diuretic effect as well, which may be beneficial.

Dietary supplements in beverage or other form in accordance with the present invention may be technically functional (have some actual, particular function) that avoid the “brute force” approach of most conventional functional beverages or other forms. Through mixtures of enzymes and vitamins (which may include herbs, minerals and other materials), such supplements often appear to require use of less of the individual ingredients to deliver the desired effect; that is, the ingredients appear to work together to have a greater active effect—a synergy.

Dietary supplements in accordance with the present invention in beverage or other form may be low in calories. In beverage form, they may contain less than 5 or even less than 3 calories per fluid ounce. These supplements may be low enough in calories to be consumed on a daily basis without the worry of gaining weight.

As described further below, dietary supplements in accordance with the present invention may be produced by combining enzymes, vitamins, flavors, and/or other ingredients, which might be mixed in a vat at a production plant. For supplements in beverage form at least, at the time of mixing, water may added, preferably carbonated water and more preferably at a suitable carbonation level. In any case, the resulting mixture might then be sent to filling or other machines, which in turn place the mixture into cans, bottles or other containers. Once filled, containers may enter a conveyor that pulls them through a pasteurization process. The containers may be cleaned, packed into cases and stacked into pallets, etc. Dietary supplements in accordance with the present invention may be provided in various forms in addition to a beverage form, such as a powder, pill, bar, etc.

Dietary supplements in accordance with the present invention may be, in one implementation, a flavored “vitamin” beverage; the flavor may be fruit flavor, such as blood orange flavor. Main active ingredients may be an enzyme blend and/or a vitamin mix. The enzymes are a catalyst of biological function and are usually selected to mitigate inflammation and may have other effects. In one embodiment, the vitamin mix comprises a ginger root extract, a green tea extract and a milk thistle extract, and these ingredients may also add to the anti-inflammatory effect of the beverage. The green tea extract may act as a thermogenic and help to burn calories. The beverage may have similar effects as Motrin® (a type of ibuprofen based medication) without a negative effect on the liver, whereas the ingredients of the beverage are selected with the objective of improving liver function. The enzymes may also metabolize alcohol in the body before the liver needs to respond to it.

In this disclosure and the claims that follow, it should be understood that the various materials recited together in the same context should be understood as non-overlapping, unless otherwise indicated. For example, an herbal (herein, at least one of various forms (including parts and/or extracts) of ginger root, green tea, ginseng root or milk thistle) may naturally contain another material as a constituent that is recited together with this herbal in the same context herein, so when such an herbal and such a constituent material are recited together herein in the same context, the constituent material should be understood to be in addition to and distinct from that which might be naturally part of the herbal, unless otherwise indicated.

Also in this disclosure and the claims that follow, it should be understood that when reference is made to vitamins B2, B3, B5, B12 and/or vitamin E, such designation should be understood to include the various forms that such vitamins may be provided in, as understood by those of ordinary skill in the art, unless otherwise indicated. Some non-limiting examples would be: for vitamin B2—riboflavin and/or its phosphate; for vitamin B3—niacin and/or niacinamide; for vitamin B5—pantothenic acid, pantothenate (calcium or other) and/or panthenol; for vitamin B12—cobalamin and/or cyanocobalamin; and for vitamin E-alpha—tocopherol, vitamin E acetate and/or alpha-tocopherol acetate.

In this disclosure and the claims that follow, unless otherwise indicated, the terms vitamin, vitamin mix, vitamin component etc. are used expansively so as to allow for inclusion of regular vitamins, as well as herbals, minerals and (as indicated elsewhere herein more specifically) certain other material useful to the body, but excluding enzymes, water and (as may be indicated elsewhere herein more specifically) certain other materials.

One or more herbals may be included in dietary supplements in accordance with the present invention including ginger root, green tea, ginseng root and/or milk thistle. These may be in various forms (including parts and/or extracts), but would preferably be in a form easily dispersible such as a powder, such as ginseng root powder (such as of the Panax type) in the case of ginseng root. Any extracts of these herbal materials may be used, such any of the various ginger root extracts, green tea extracts, ginseng root extracts and/or milk thistle extracts. Any particular types of these extracts may be specified and used, with the specification keyed to how they are made, a particular reference component in the extract such as in an EGCG green tea extract or 90% (by weight) EGCG green tea extract, a particular part of the plant material used such as seeds as in milk thistle seed extract, and/or others.

One or more sweeteners may be included in dietary supplements in accordance with the present invention. Sugars such as sucrose or fructose, as well as others known in the art for such purpose, may be used. Sugar substitutes such as sugar alcohols (like sorbitol or xylitol), saccharin, aspartame, sucralose, neotame, acesulfame potassium, stevia or cyclamates, as well as others, may be used. Many sugar substitutes do not add significant calories to the supplements to which they are added which may be an advantage.

It may be desirable that dietary supplements in accordance with the present invention be pasteurized, especially when in the beverage form. Even if not a requirement, pasteurization would probably significantly increase shelf life.

Dietary supplements in accordance with the present invention may be useful in various general or particular situations. Some particular situations of special interest include before, during and/or after sports or other physical activity; before, during and/or after consumption of alcoholic beverages for hangover prevention or alleviation; as an anti-nausea aide; as a general or particular anti-inflammatory and/or anti-pain aide; and/or as an anti-rash aide. The supplements may be consumed and/or applied topically in these instances as applicable; they may be injected in certain instances if proper precautions are taken.

In this disclosure and the claims that follow, unless otherwise indicated, material compositions (such as percentages) are on a weight (mass) basis.

Various dietary supplements, methods of making them and methods of using them, in accordance with the present invention, will now be presented.

One dietary supplement in accordance with the present invention comprises an enzyme component and a vitamin component. Enzyme component should be understood to mean one or more enzymes that are part of the dietary supplement, and vitamin component should be understood to be one or more vitamins that are part of the dietary supplement. Vitamins are defined here so as to include regular vitamins as well as herbals, minerals and (as indicated elsewhere herein more specifically) certain other material useful to the body, but excluding enzymes, water and (as may be indicated elsewhere herein more specifically) certain other materials.

Some embodiments of this dietary supplement in accordance with the present invention include those wherein the enzyme component comprises at least one enzyme selected from the group consisting of bromelain and serrapeptase, and the vitamin component comprises ginger root or in an alternate, a ginger root extract. In another alternate, the vitamin component comprises at least one item selected from the group consisting of a ginger root extract, milk thistle, vitamin E and a green tea extract, and in still another alternate, the vitamin component comprises a ginger root extract and at least one item selected from the group consisting of milk thistle, vitamin E and a green tea extract. In yet another alternate, the vitamin component comprises a ginger root extract, a milk thistle extract and a green tea extract.

In other embodiments of this dietary supplement in accordance with the present invention, the enzyme component comprises bromelain and serrapeptase, and the vitamin component comprises at least one item selected from the group consisting of a ginger root extract, milk thistle, vitamin E and a green tea extract. In an alternate, the vitamin component comprises a ginger root extract and at least one item selected from the group consisting of milk thistle, vitamin E and a green tea extract. In another alternate, the vitamin component comprises a ginger root extract, a milk thistle extract and a green tea extract. In yet another alternate, the vitamin component comprises a ginger root extract, milk thistle, vitamin E and a green tea extract.

Many of these embodiments (and others as well) of the aforementioned dietary supplement in accordance with the present invention may be summarized as having an enzyme component comprising bromelain and/or serrappetase and a vitamin component comprising various combinations of one or more of ginger root, a ginger root extract, milk thistle, a milk thistle extract, vitamin E and a green tea extract. These combinations are hereby disclosed individually as alternates if not already disclosed.

The various forms of the herbals are discussed elsewhere herein and may be used to provide further alternates for the dietary supplements disclosed herein. For example, the green tea extract may be an EGCG green tea extract.

The dietary supplements disclosed herein may alternately further comprise one or more sweeteners, which are described more specifically elsewhere herein, and/or water (which may be carbonated water), and/or an agent imparting a flavor (such as a fruit flavor), and/or may have a caloric content of less than 3 or less than 5 calories per fluid ounce or weight/mass ounce.

In some other embodiments of the aforementioned dietary supplement in accordance with the present invention, the enzyme component comprises at least one item selected from the group consisting of bromelain, lipase, amylase, protease other than bromelain or serrapeptase, invertase, beta-glucanase and serrapeptase, and the vitamin component comprises at least one item selected from the group consisting of vitamin B2, vitamin B3, vitamin B5, vitamin B12, sodium chloride, monopotassium phosphate, sodium citrate, citric acid, caffeine, d-glucuronolactate, a ginger root extract, a green tea extract, inositol, ginseng root, taurine, milk thistle and vitamin E. Alternates are hereby disclosed based on the number selected from each list; this includes all the various combinations of 1 or more, 2 or more, 3 or more, . . . to 7 for the enzyme list with 1 or more, 2 or more, 3 or more, . . . to 17 for the vitamin list. For example, 2 or more from each list, 4 or more from each list, or 4 or more from the enzyme list and 8 or more from the vitamin list. In other alternates, the enzyme component comprises bromelain and/or serrapeptase and at least one enzyme from the rest of the enzyme list, and the vitamin component comprises a ginger root extract and at least one item from the rest of the vitamin list; alternately, other additional numbers of items may be selected from the enzyme and vitamin lists up to the maximum remaining for each and all combinations of these are hereby disclosed—for example, 1 or more for the enzymes and 2 or more for the vitamins; and 2 or more for the enzymes and 8 or more for the vitamins.

In still another embodiment of the aforementioned dietary supplement in accordance with the present invention, the enzyme component comprises bromelain, lipase, amylase, protease other than bromelain or serrapeptase, invertase, beta-glucanase and serrapeptase, and the vitamin component comprises vitamin B2, vitamin B3, vitamin B5, vitamin B12, sodium chloride, monopotassium phosphate, sodium citrate, citric acid, caffeine, d-glucuronolactate, a ginger root extract, a green tea extract, inositol, ginseng root, taurine, milk thistle and vitamin E. Alternates, hereby specifically disclosed, are where the enzyme component comprises any specific subset of the immediately foregoing list of enzymes and/or where the vitamin component comprises any specific subset of the immediately foregoing list corresponding.

In the dietary supplements herein where protease other than bromelain or serrapeptase is called out, this protease may be a multiple protease such as protease 4.5; serrapeptase may be Serrazimes® (by National Enzyme).

Any of the dietary supplements herein may undergo pasteurization.

In further alternates of the dietary supplements disclosed herein, the herbals may make up less than 99%, 95%, 90%, 75%, 50%, 25%, 20%, 15%, 10%, 5%, 1%, 0.5% or 0.1% by weight of the vitamin component, or the herbals are within a range of percent by weight of the vitamin component formed by using any of these numbers and any other of these numbers larger than it (if any), such as 1-75 weight %, 15-25 weight %, 1-5 weight %, etc with all these ranges hereby specifically disclosed as alternates. Further alternates include applying these “less thans” and ranges to specific subsets of the herbals and are hereby disclosed.

Methods of making dietary supplements in accordance with the present invention are also provided. One such method comprises mixing a group of materials comprising an enzyme component comprising at least one item selected from the group consisting of bromelain and serapaptase and a vitamin component comprising a ginger root extract. Alternately, the group of materials mixed comprises bromelain, lipase, amylase, protease other than bromelain or serrapeptase, invertase, beta-glucanase, serrapeptase, vitamin B2, vitamin B3, vitamin B5, vitamin B12, sodium chloride, monopotassium phosphate, sodium citrate, citric acid, caffeine, d-glucuronolactate, a ginger root extract, a green tea extract, inositol, ginseng root, taurine, milk thistle and vitamin E, or some specific subset of this list, all of which are hereby disclosed. Alternately, the group of materials mixed further comprises water which may be carbonated water and/or the method further comprises pasteurizing the combination resulting from the mixing.

Methods of using dietary supplements in accordance with the present invention are also provided. One such method is for treatment and comprises administering a specific dietary supplement in accordance with the present invention—any of these supplements may be used. Treatment is used here in a very general manner and relates to situations such as use before, during and/or after sports or other physical activity; before, during or after consumption of alcoholic beverages for hangover prevention or alleviation; as an anti-nausea aide; as a general or particular anti-inflammatory and/or anti-pain aide; and/or as an anti-rash aide. Administering the supplements may include their consumption, topical application and even injection as appropriate and applicable, as well as by other techniques known or that become known in the art for such purpose.

In the dietary supplements and methods in accordance with the present invention disclosed, any applicable combination of alternates may be applied to produce further alternates which are hereby disclosed.

The following examples should be taken as illustrative, but should not be interpreted so as to unnecessarily limit the scope of this disclosure or the claims that follow. At least portions of these examples are prophetic.

### Example 1

The following is a listing of the ingredients for 1000 gallons (3785.4 liters) of an exemplary beverage in accordance with the present invention with a blood orange flavor. It should be noted that this is an exemplary embodiment and variations on the specific ingredients and proportions of ingredients may be used. For example, the ingredients in the vitamin mix and the enzyme blends may be varied. Also, other flavoring or colorings may be used. The proportions of the vitamin mix and enzyme blends in the drink may be varied. Other suitable combination of ingredients may be used.

| Ingredient | Amount | |
|---|---|---|
| Sucralose | 2.23 | lb (1.01 kg) |
| Citric Acid | 32.55 | lb (14.76 kg) |
| Vitamin Mix | 49.24 | lb (22.33 kg) |
| Orange Flavor | 28.79 | lb (13.06 kg) |
| Enzyme Blend | 4.42 | lb (2.00 kg) |
| Peach Dispersion Color | 1.42 | lb (0.64 kg) |
| Bring with Water to . . . | 1000 | gal (3785.4 liters) |
| | 1000.00 | gal (3785.4 liters) |

The orange flavor may be blood orange flavor or other suitable flavoring. The vitamin mix is described further below, and the enzyme blend is also described further below, and in one implementation may be currently obtained from the National Enzyme Company. The peach dispersion color may be peach dispersion color from Sensient Co., or any other suitable coloring. As described above, the ingredients are mixed and may be carbonated and/or pasteurized.

The ingredients in the vitamin mix are described below. They may be added to the total mix in the ratio implied below.

Vitamin Mix

Vitamin B3 (as Niacinamide) 4 mg

Vitamin B5 (as d-Calcium Pantothenate) 2 mg

Vitamin B12 (as Cyanocobalamin) 1.2 mcg

Vitamin B2 (as Riboflavin) 0.34 mg

Chloride (from Sodium Chloride) 49 mg

Phosphorus (from Monopotassium Phosphate) 30 mg

Potassium (from Monopotassium Phosphate) 37 mg

Sodium (from Chloride & Citrate) 65 mg

Caffeine 25 mg

d-Glucuronolactate 250 mg

Ginger Root Extract 50 mg (any extract type may be used)

Green Tea Extract (90% by weight EGCG) 25 mg

Inositol 25 mg

Ginseng Root 25 mg (any type, preferably powder, such as Panax powder OK)

Taurine 400 mg

Sodium Citrate 146 mg

Milk Thistle 25 mg (any type OK, including extracts, like any seed extract)

Vitamin E Acetate 30 IU

Carrier (Citric Acid) with amount varied according to taste and/or volume desired

In one implementation, the vitamin mix is optimally stored in a cool (46-59 deg F., 7.8-15 deg C.), dry (50% R.H.) place in an original sealed container, and may be stored as above 12 months from the date of manufacture. However, results obtained may vary with various manufacturing conditions, processes and techniques. In one implementation, the beverage may use approximately 1,400 mg of the vitamin mix per serving, with a serving being 8-12 fluid ounces.

The ingredients in the enzyme blend are described below. Again, they may be added to the total mix in the ratio implied below.

Enzyme Blend 175 mg

Bromelain 750000 FCCPU

Lipase 250 FIP

Amylase 1000 DU

Protease 4.5, 2500 HUT

Invertase 250 SU

Beta-glucanase 87.5 BGU

Serrazimes® 15000 U (serrapeptase by National Enzyme)

The peach dispersion is described further below. Again, it may be added to the total mix in the ratio implied below.

Peach Dispersion

Description: A reddish-orange water dispersible liquid containing water, sugar, propylene glycol, sorbitol, modified food starch, isomalt, beta-carotene, cornstarch, sodium ascorbate, dl-alpha tocopherol, ascorbic acid, tricalcium phosphate, methyl paraben, propyl paraben, and phosphoric acid.

Specific gravity: 1.1-1.3

pH: 4.0-8.0

Applications: It is designed for use in beverages, fruit flavors and fillings, frozen novelties, candies, baked goods and other applications where a water dispersible beta-carotene is needed.

Storage: It should be stored in a closed container at 50-120 deg F. (10-48.9 deg C.). It should be stored in a tightly closed container to prevent evaporation, and as it may settle upon storage, so agitation or shaking prior to use is recommended.

Shelf life: It is best used within six months from date of manufacture when stored under recommended storage conditions.

### Example 2

Below is information regarding an implementation of a beverage in accordance with the present invention. In a serving of 12 fluid ounces (355 ml): Calories 20

Vitamin B3 (as Niacinamide) 6 mg

Vitamin B5 (as d-Calcium Pantothenate) 3 mg

Vitamin B12 (as Cyanocobalamin) 1.8 mcg

Vitamin B2 (as Riboflavin) 0.51 mg

Chloride (from Sodium Chloride) 73.5 mg

Phosphorus (from Monopotassium Phosphate) 45 mg

Potassium (from Monopotassium Phosphate) 37 mg

Sodium (from Chloride and Citrate) 65 mg

Vitamin E Acetate 30 mg

Vitamin & Enzyme Blend 1462 mg (variations, ratios and enzyme blend type as in example 1)

Taurine, d-Glucuronolactate, Sodium Citrate, Ginger Root extract, Caffeine, Green Tea Extract (standardized to 90% by weight EGCG), Inositol, Ginseng Root, Milk Thistle, Bromelain, Lipase, Amylase, Protease 4.5, Invertase, beta-Glucanase and Serrazimes®.

Other ingredients: Carbonated Water, Citric Acid, Natural Flavors, Sucralose and beta-Carotene for color.

### Example 3

An implementation of a beverage in accordance with the present invention is described. The following relates to a 12 fluid ounce (355 ml) serving of this beverage. It contains 15 calories, 5 of which are from fat, has a total fat content of 0.5 g, a sodium content of 100 mg and a total carbohydrate content of 3 g. It contains a 2193 mg vitamin and enzyme blend (variation, ratios and enzyme blend type as in example 1) made up of d-glucuronolactate, sodium citrate, a ginger root extract, caffeine, green tea extract (90% by weight EGCG), inositol, ginseng root, milk thistle, taurine, bromelain, lipase, amylase, protease 4.5, invertase, beta-glucanase and Serrazimes®. In addition, it contains vitamin B3 (6 mg), vitamin B5 (3 mg), vitamin B12 (1.8 mcg), vitamin B2 (0.51 mg), chloride (74 mg), phosphorus (45 mg), potassium (56 mg) and vitamin E acetate (45 mg). Other ingredients are carbonated water, citric acid, natural flavors, sucralose, and beta-carotene for color. It is pasteurized and preferably chilled and shaken gently before serving; it is further recommended that if consumed during a workout that it be mixed with equal parts water first.

### Example 4

Below is a nutrient analysis in accordance with an implementation of a beverage consistent with the present invention (similar to that in example 1, 2 and/or 3). For this analysis, the exemplary serving size was 12 fluid ounces (355 ml).

ANALYSIS RESULTS

| Analysis | Found | per serving | Method |
|---|---|---|---|
| Moisture | 99.10% | 351.8 g | AOAC |
| Protein | 0.08% | 0.28 g | LECO 2000 |
| Fat | 0.16% | 0.57 g | AOAC |
| Ash | n.d. % | n.d. g | AOAC |
| Carbohydrates | 0.66% | 2.34 g | CALCULATION |
| Calories | | 16 Cal | 21 CFR PART 101.9 (CALC) |
| Total Dietary Fiber | n.d. % | n.d. g | AOAC 991.43 |
| Cholesterol | n.d. mg/100 g | n.d. mg | USFDA\979.19 |
| Fatty Acids | | | |
| Saturated | n.d. % of fat | n.d. g | USFDA |
| Mono-unsaturated | 69.8% of fat | 0.40 g | USFDA |
| Poly-unsaturated | 30.2% of fat | 0.17 g | USFDA |
| Trans Fatty Acids | n.d. % of fat | n.d. g | USFDA |
| Vitamins | | | |
| Vitamin A | 13.74 IU/100 g | 48.76 IU | USFDA |
| Vitamin C | n.d. mg/100 g | n.d. mg | AOAC\MULTI. FOOD\HPLC-FL. |
| Minerals | | | |
| Sodium | 283.1 ppm | 100.5 mg | ICAP |
| Potassium | 131.9 ppm | 46.82 mg | ICAP |
| Calcium | 4.58 ppm | 1.63 mg | ICAP |
| Iron | 0.34 ppm | 0.12 mg | ICAP |
| Sugars | | | |
| Sucrose | n.d. % | n.d. g | HOT H2O EXTRACT - HPLC-RI |
| Glucose | n.d. % | n.d. g | HOT H2O EXTRACT - HPLC-RI |
| Fructose | n.d. % | n.d. g | HOT H2O EXTRACT - HPLC-RI |
| Lactose | n.d. % | n.d. g | HOT H2O EXTRACT - HPLC-RI |
| Maltose | n.d. % | n.d. g | HOT H2O EXTRACT - HPLC-RI |

The previous disclosure of various embodiments provides illustration and description, but it is not intended to be exhaustive or to limit the invention to the precise form disclosed. Modifications and variations are possible in light of the above teachings or may be acquired from practice in accordance with the present invention. It is to be understood that the invention is intended to cover various modifications and equivalent arrangements included within the spirit and scope of the claims that follow.

What is claimed is:

1. A dietary supplement comprising an enzyme component and a vitamin component.

2. The dietary supplement of claim 1 wherein the enzyme component comprises at least one enzyme selected from the group consisting of bromelain and serrapeptase, and the vitamin component comprises ginger root.

3. The dietary supplement of claim 1 wherein the enzyme component comprises at least one enzyme selected from the group consisting of bromelain and serrapeptase, and the vitamin component comprises a ginger root extract.

4. The dietary supplement of claim 1 wherein the enzyme component comprises at least one enzyme selected from the group consisting of bromelain and serrapeptase, and the vitamin component comprises at least one item selected from the group consisting of a ginger root extract, milk thistle, vitamin E and a green tea extract.

5. The dietary supplement of claim 4 wherein the vitamin component comprises a ginger root extract and at least one item selected from the group consisting of milk thistle, vitamin E and a green tea extract.

6. The dietary supplement of claim 1 wherein the enzyme component comprises at least one enzyme selected from the group consisting of bromelain and serrapeptase, and the vitamin component comprises a ginger root extract, a milk thistle extract and a green tea extract.

7. The dietary supplement of claim 1 wherein the enzyme component comprises bromelain and serrapeptase, and the vitamin component comprises at least one item selected from the group consisting of a ginger root extract, milk thistle, vitamin E and a green tea extract.

8. The dietary supplement of claim 1 wherein the enzyme component comprises bromelain and serrapeptase, and the vitamin component comprises a ginger root extract and at least one item selected from the group consisting of milk thistle, vitamin E and a green tea extract.

9. The dietary supplement of claim 1 wherein the enzyme component comprises bromelain and serrapeptase, and the vitamin component comprises a ginger root extract, a milk thistle extract and a green tea extract.

10. The dietary supplement of claim 1 wherein the enzyme component comprises bromelain and serrapeptase, and the vitamin component comprises a ginger root extract, milk thistle, vitamin E and a green tea extract.

11. The dietary supplement of claim 5 wherein the green tea extract is an EGCG green tea extract.

12. The dietary supplement of claim 8 wherein the green tea extract is an EGCG green tea extract.

13. The dietary supplement of claim 10 wherein the green tea extract is an EGCG green tea extract.

14. The dietary supplement of claim 3 further comprising a sweetener.

15. The dietary supplement of claim 8 further comprising a sweetener.

16. The dietary supplement of claim 3 further comprising carbonated water.

17. The dietary supplement of claim 8 further comprising carbonated water.

18. The dietary supplement of claim 3 further comprising water and wherein the caloric content per fluid ounce is less than 5.

19. The dietary supplement of claim 8 further comprising water and wherein the caloric content per fluid ounce is less than 5.

20. The dietary supplement of claim 1 wherein the enzyme component comprises at least one item selected from the group consisting of bromelain, lipase, amylase, protease other than bromelain or serrapeptase, invertase, beta-glucanase and serrapeptase, and the vitamin component comprises at least one item selected from the group consisting of vitamin B2, vitamin B3, vitamin B5, vitamin B12, sodium chloride, monopotassium phosphate, sodium citrate, citric acid, caffeine, d-glucuronolactate, a ginger root extract, a green tea extract, inositol, ginseng root, taurine, milk thistle and vitamin E.

21. The dietary supplement of claim 20 further comprising a sweetener and an agent imparting a fruit flavor.

22. The dietary supplement of claim 21 further comprising water and wherein the caloric content per fluid ounce is less than 5.

23. The dietary supplement of claim 1 wherein the enzyme component comprises bromelain and at least one item selected from the group consisting of lipase, amylase, protease other than bromelain or serrapeptase, invertase, beta-glucanase, and serrapeptase, and the vitamin component comprises a ginger root extract and at least one item selected from the group consisting of vitamin B2, vitamin B3, vitamin B5, vitamin B12, sodium chloride, monopotassium phosphate, sodium citrate, citric acid, caffeine, d-glucuronolactate, a green tea extract, inositol, ginseng root, taurine, milk thistle and vitamin E.

24. The dietary supplement of claim 1 wherein the enzyme component comprises serrapeptase and at least one item selected from the group consisting of bromelain, lipase, amylase, protease other than bromelain or serrapeptase, invertase and beta-glucanase, and the vitamin component comprises a ginger root extract and at least one item selected from the group consisting of vitamin B2, vitamin B3, vitamin B5, vitamin B12, sodium chloride, monopotassium phosphate, sodium citrate, citric acid, caffeine, d-glucuronolactate, a green tea extract, inositol, ginseng root, taurine, milk thistle and vitamin E.

25. The dietary supplement of claim 1 wherein the enzyme component comprises two or more items selected from the group consisting of bromelain, lipase, amylase, protease other than bromelain or serrapeptase, invertase, beta-glucanase and serrapeptase, and the vitamin component comprises two or more items selected from the group consisting of vitamin B2, vitamin B3, vitamin B5, vitamin B12, sodium chloride, monopotassium phosphate, sodium citrate, citric acid, caffeine, d-glucuronolactate, a ginger root extract, a green tea extract, inositol, ginseng root, taurine, milk thistle and vitamin E.

26. The dietary supplement of claim 1 wherein the enzyme component comprises four or more items selected from the group consisting of bromelain, lipase, amylase, protease other than bromelain or serrapeptase, invertase, beta-glucanase and serrapeptase, and the vitamin component comprises four or more items selected from the group consisting of vitamin B2, vitamin B3, vitamin B5, vitamin B12, sodium chloride, monopotassium phosphate, sodium citrate, citric acid, caffeine, d-glucuronolactate, a ginger root extract, a green tea extract, inositol, ginseng root, taurine, milk thistle and vitamin E.

27. The dietary supplement of claim 1 wherein the enzyme component comprises four or more items selected from the group consisting of bromelain, lipase, amylase, protease other than bromelain or serrapeptase, invertase, beta-glucanase and serrapeptase, and the vitamin component comprises eight or more items selected from the group consisting of vitamin B2, vitamin B3, vitamin B5, vitamin B12, sodium chloride, monopotassium phosphate, sodium citrate, citric acid, caffeine, d-glucuronolactate, a ginger root extract, a green tea extract, inositol, ginseng root, taurine, milk thistle and vitamin E.

28. The dietary supplement of claim 1 wherein the enzyme component comprises bromelain and serrapeptase and at least one item selected from the group consisting of lipase, amylase, protease other than bromelain or serrapeptase, invertase and beta-glucanase, and the vitamin component comprises a ginger root extract and at least two items selected from the group consisting of vitamin B2, vitamin B3, vitamin B5, vitamin B12, sodium chloride, monopotassium phosphate, sodium citrate, citric acid, caffeine, d-glucuronolactate, a green tea extract, inositol, ginseng root, taurine, milk thistle and vitamin E.

29. The dietary supplement of claim 1 wherein the enzyme component comprises bromelain and serrapeptase and at least two items selected from the group consisting of lipase, amylase, protease other than bromelain or serrapeptase, invertase and beta-glucanase, and the vitamin component comprises a ginger root extract and at least eight items selected from the group consisting of vitamin B2, vitamin B3, vitamin B5, vitamin B12, sodium chloride, monopotassium phosphate, sodium citrate, citric acid, caffeine, d-glucuronolactate, a green tea extract, inositol, ginseng root, taurine, milk thistle and vitamin E.

30. The dietary supplement of claim 1 wherein the enzyme component comprises bromelain, lipase, amylase, protease other than bromelain or serrapeptase, invertase, beta-glucanase and serrapeptase, and the vitamin component comprises vitamin B2, vitamin B3, vitamin B5, vitamin B12, sodium chloride, monopotassium phosphate, sodium citrate, citric acid, caffeine, d-glucuronolactate, a ginger root extract, a green tea extract, inositol, ginseng root, taurine, milk thistle and vitamin E.

31. The dietary supplement of claim 30 further comprising a sweetener and an agent imparting a fruit flavor.

32. The dietary supplement of claim 31 further comprising water.

33. The dietary supplement of claim 32 wherein the caloric content per fluid ounce is less than 5.

34. The dietary supplement of claim 3 that has undergone pasteurization.

35. The dietary supplement of claim 8 that has undergone pasteurization.

36. The dietary supplement of claim 20 that has undergone pasteurization.

37. The dietary supplement of claim 25 that has undergone pasteurization.

38. A method of making a dietary supplement comprising mixing a group of materials comprising an enzyme component comprising at least one item selected from the group consisting of bromelain and serapaptase and a vitamin component comprising a ginger root extract.

39. The method of claim 38 wherein the group of materials mixed further comprises water.

40. The method of claim 39 wherein the water is carbonated water.

41. The method of claim 38 further comprising pasteurizing the combination resulting from the mixing.

42. The method of claim 38 wherein the group of materials mixed comprises bromelain, lipase, amylase, protease other than bromelain or serrapeptase, invertase, beta-glucanase, serrapeptase, vitamin B2, vitamin B3, vitamin B5, vitamin B12, sodium chloride, monopotassium phosphate, sodium citrate, citric acid, caffeine, d-glucuronolactate, a ginger root extract, a green tea extract, inositol, ginseng root, taurine, milk thistle and vitamin E.

43. A method of treatment comprising administering the dietary supplement of claim 3.

44. A method of treatment comprising administering the dietary supplement of claim 8.

45. A method of treatment comprising administering the dietary supplement of claim 30.

46. The dietary supplement according to claim 23 wherein the ginger root extract plus any green tea extract, ginseng root and milk thistle present make up less than 50% by weight of the vitamin component.

47. The dietary supplement according to claim 24 wherein the ginger root extract plus any green tea extract, ginseng root and milk thistle present make up less than 50% by weight of the vitamin component.

48. The dietary supplement according to claim 30 wherein the ginger root extract, the green tea extract, ginseng root and milk thistle together make up less than 25% by weight of the vitamin component.
